(19) United States
(12) Patent Application Publication
(10) Pub. No.: US 2020/0117770 A1
(43) Pub. Date: Apr. 16, 2020

(54) DEVICE, METHODS, AND GRAPHICAL INTERFACES FOR DETERMINATION AND PREDICTION OF CHEMICAL TECHNOLOGY SYSTEM PARAMETERS

(71) Applicant: CHEMICAL TECHNOLOGIES, INC., Wilmington, DE (US)

(72) Inventors: Oleg Valeryevich GIIAZOV, Saint-Petersburg (RU); Artem Anatolevich ERMULIN, Kirishi (RU); Alexander Valeryevich MIDYUTOV, Saint-Petersburg (RU); Evgenii Dmitrievich BUNIN, Saint-Petersburg (RU); Dmitry Nikolaevich SHALUPKIN, Saint Petersburg (RU); Georgii Anatolievich STREMOUSOV, Saint-Petersburg (RU)

(21) Appl. No.: 16/157,439

(22) Filed: Oct. 11, 2018

(51) Int. Cl. G06F 19/00

(52) U.S. Cl. CPC G06F 19/702; G06F 2217/16

(57) ABSTRACT

System and calculation method for parameters of a chemical technology system, which are not measured directly or indirectly, on the basis of values of measured chemical technology system parameters with the use of the mathematical models and a portable computing device with a dedicated graphical interface.

Optimal and efficient control of technology and chemical technology processes requires the availability of correct and timely information on process parameters, including component-wise compositions of process flows, temperature, pressure, level, and many others. The technical process parameters are required for the current time point, in real time mode, historical values obtained earlier, and the need for obtaining calculation data allowing the evaluation of their values at the forecasting time interval, in future.

For the time being, the most common methods of obtaining information about the technical process parameters are represented by the installation of additional sensors and analyzers for technical process and definition of missing data under indirect data by means of the factorial analysis.

The installation of additional sensors and analyzers is accompanied by high financial and time expenditures and a large number of limitations. The part of parameters, for example, such as saturated vapor pressure or the octane number, cannot be measured in real time, installation of sensors on process flows and units with aggressive media, low or high temperature and pressure is complicated. In some cases, the installation of sensors and analyzers is impossible due to physical, climatic, or dimensional limitations. At the same time, the installation of sensors and analyzers, as a rule, requires shutting down the processing unit or its functional block; for example, in the U.S. Pat. No. 3,497,449A—Controlling a continuous process by concentration measurements—fitting the chromatograph into the pipeline is required. As a rule, this shutdown is performed from one time in several months to several years. Delay in the determination of the process parameters, for example, in the case with flow-line gas chromatographs or an analytical laboratory is a considerable disadvantage for the efficient control of the chemical technology process in real time mode. The use of the additional process sensors and analyzers requires additional resources from the qualified staff side with the purpose of permanent servicing, calibration and adjustment.

The factorial analysis as a method of determining the technical process parameters under the existing values is a very labor-consuming task. Initial data collection for factorial analysis requires the arrangement of the costly full-scale experiment directly at the chemical technology facility, including, on boundary scheduled modes, which is connected with the appearance of additional risks on the technology facility efficiency and production, product quality decrease, and its no-failure operation. The factorial analysis is not a universal method of defining the chemical technology facility missing parameters. The independent factorial analysis is required to be conducted for each parameter which leads to the proportional increase of the cost and labor intensity from the number of parameters defined. Additional difficulties and time expenditures arise at the stage of integrating the ready solution into the existing automated system of chemical technology processes control. For example, in the U.S. Pat. No. 5,935,863A—Cracking property determination and process control—preparing a bank in which the NIR spectra are recorded at many wavelengths for a large number of standard materials is required.

The method developed defines the chemical technology facility missing parameters, including those impossible to be computed by the methods described above. The method does not require the additional installation of costly equipment or conduction of time-consuming factorial analysis. The method application has no physical, climatic or dimensional limitations, as well as requirements for the availability of high-qualified staff because the interface developed has the intuitive and logical appearance. Developing the method for the certain process does not require it to be stopped. In comparison with the factorial analysis, the method developed does not require the conduction of full-scale experiments, the available historical data is sufficient; moreover, its development takes much less time. Moreover, it is possible to predict parameters on the forecasting interval, in future.

### SUMMARY OF THE INVENTION

The invention relates to defining the parameters of chemical technology systems, in particular, to the system and the calculation method for the parameters of chemical technology system, which are not measured directly or indirectly, on the basis of values of the measured chemical technology system parameters with the use of the mathematical models and portable computing device with dedicated graphical interface. Defining the chemical technology system parameters by means of this invention allows to considerably reduce the device cost price, term for implementation and expenditures on its operation in comparison with the existing primary and secondary test and measurement devices and sensors, analyzers, installed directly at the border of chemical technology systems, and external laboratories and any other sources of information on systems parameters and indices.

### DETAILED DESCRIPTION OF THE PREFERRED EMBODIMENTS

FIG. 1 represents the system and the method 100 where the portable computing device 102 on the basis of values from the database 101, obtained through the connection initialization block 106 and the data transfer component 108, Artificial Intelligence (AI) models 109, based on statistic modeling, machine learning or artificial intelligence, received from the model setting block 110, calculates one or several target parameters of the chemical technology system, with the subsequent output of values and/or trends to the graphical interface 111. These components are additionally bound under one or several communication buses or by signal lines 112.

The block 106 defines the type of communication with the database 101 by means of the external port 103 or the image registration object 104 of the portable computing device 102 according to the method 200, shown in FIG. 2. The block 108 contains the entire required set of program scripts which are necessary for the interaction with the bound components 105, 106, 107, 109, and data transfer between the data.

Values from the database 101, under the communication type determined in block 106, are placed into the database 107 of the portable computing device 102 through the data transfer component 108. From the database 107 of the portable computing device 102, the values are introduced into AI models 109. AI models 109 are set up in the setting block of AI models 110 according to the means 300 on FIG. 3.

AI models 109 calculation results are saved into the database 107 and are displayed on the graphical interface 111 according to the method 400, in FIG. 4A, 4B.

The portable computing device 102 contains the orchestrator 105, performing the placement, coordination and control between the blocks 107, 108, 109, 111 of the portable computing device 102.

Method 200

FIG. 2 shows the method 200 for the definition of the type of communication of the portable computing device 102 with the database 101. The method starts in block 201, where the connection type is selected.

If the connection is established under Open Systems Interconnection basic reference model (OSI), then the OSI model level (physical, channel, network, transport, session, representative, applied) is selected in block 202. After the OSI model level selection, the protocol of connection selected in block 202 of the OSI model level, is determined in block 203. After the connection protocol definition, connection with the database is established in block 204.

The connection established in block 204 is able to receive values from the database, but not to send the values to the database. This provides the database safety and preservation from such changes as addition/deletion of columns/rows or separate values in the arbitrary database cell.

If the connection does not follow the OSI model, detection, tracking and classification of objects on information reproduction and visual display devices of the chemical technology system such as dispatcher consoles, operator panels, personal computer displays, tablet computers and other devices with the possibility of information graphical display and having access to values of chemical technology system process parameters is performed in block 205 by means of the image registration module 104. The values displayed should contain complete and necessary information on values of chemical technology facility sensors in the form of a collection of the signal devices and the equipment signal images, internal communications of one or several controlled facilities, parameter values, units of measurement, etc.

In block 206, values from the information chemical technology system reproduction and visual display devices are initialized with the purpose to determine values of process parameters, the corresponding units of measurement, the process parameter measurement point and the respective process equipment unit.

Values, recognized in block 206, are processed in block 207 into the form corresponding to the similar values in the database 101. The type of interaction with the database 101 by means of the image registration module 104 provides the chemical technology system safety and preservation from changes.

Method 300

FIG. 3 represents the method 300 of AI models 109 setup for one or several chemical technology system process parameters.

The method 300 starts in the data preprocessing block 301. Data preprocessing includes supplementing missing data of process parameters, deletion of escapes and any other methods, and data processing methods known to the specialist in this technical field. Further, the AI models pattern from the AI models library 303 is selected in block 302. AI models in the library 303 are statistical modeling, machine learning or artificial intelligence models. The AI models library consists of AI models patterns of various chemical technology processes 304. Each set of patterns of AI models of chemical technology processes 304 contains the set of AI models patterns of the chemical technology process equipment units. The type and kind of AI models equations are selected to enable the result of calculation of one or several AI models selected to describe the chemical technology process generalized equipment unit in the most exact way. Mathematical models have the high generalizing ability, i.e., determining functional regularities which differ from the training sample data. Further, the selected AI models pattern is adapted for the certain chemical technology process equipment unit with regard to its features in block 306. The AI models setting process is represented by changing initial data for the AI models setting process through addition/deletion of one or several process parameters, and/or changing AI models pattern parameters or otherwise, in a way contributing to the reduction of AI models calculation errors known to a specialist in this technology field. Verification of AI models calculation error value is performed in block 307 until the calculation error is lower than the permissible value.

Further, the AI models in block 308 are introduced into the block 109 of the portable computing device 102.

Method 400

FIG. 4A represents the frontal view of the portable computing device 102.

The portable computing device, defined as 401 in FIG. 4A, consists of the sensor display 402, the external port for connecting peripheral devices 404.

The graphical interface 111 is shown on the sensor display 402; it consists of an information area 403 which may contain information on the battery charge, current time, the graphical interface name, the product name 426, etc.; the area of graphical display of values 405 which may contain any kinds of graphical display of values, calculated by AI models 109, for example, the graph line 411 with the process parameter values at the current time point 412 and values at one 413 or several time points in future; the area of tabular display of values 408 which may contain any kinds of tabular display of values, calculated by AI models 109, for example, a table with names of columns 414, 415, 416, names of calculated parameters of the first 417, the second 420, etc. until the n^{th} 423 parameter and the corresponding values at the current time point 418, 421, 424 and the time point in future 419, 422 and 425; the area 406 of graphical display of the chemical technology system equipment unit and/or material flows, with the specification of one or several points of the chemical technology system for which the calculation of parameters is performed.

To control the sensor display 402 graphical interface, the user may choose one or more graphical images of calculation values with one or several fingers 407 (not to scale the drawing).

FIG. 4B shows the rear view of the portable computing device 102.

On the portable computing device 401 rear side, the image registration module 409 and the artificial illumination source 410 are located.

### BRIEF DESCRIPTION OF THE DRAWINGS (DESCRIPTION OF THE DRAWINGS)

FIG. 1—System and method for calculating one or several parameters of the chemical technology system;

FIG. 2—Method of the connection initialization with the external database;

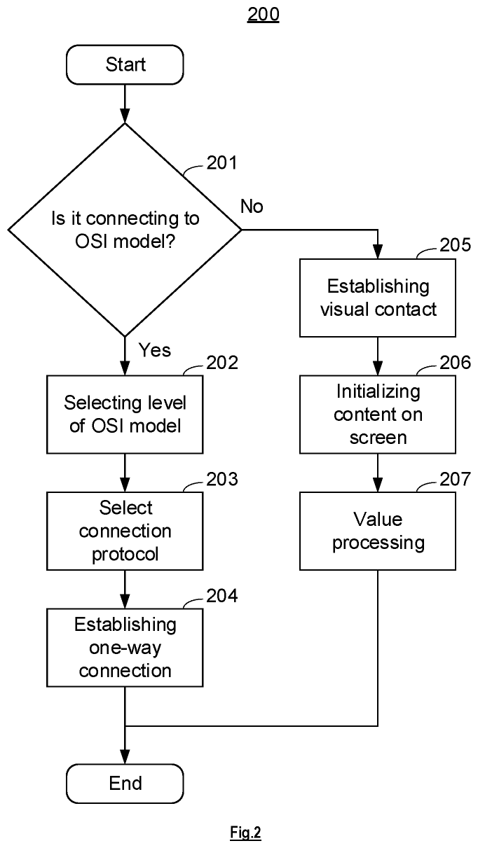

FIG. 3—Method of AI models setting;

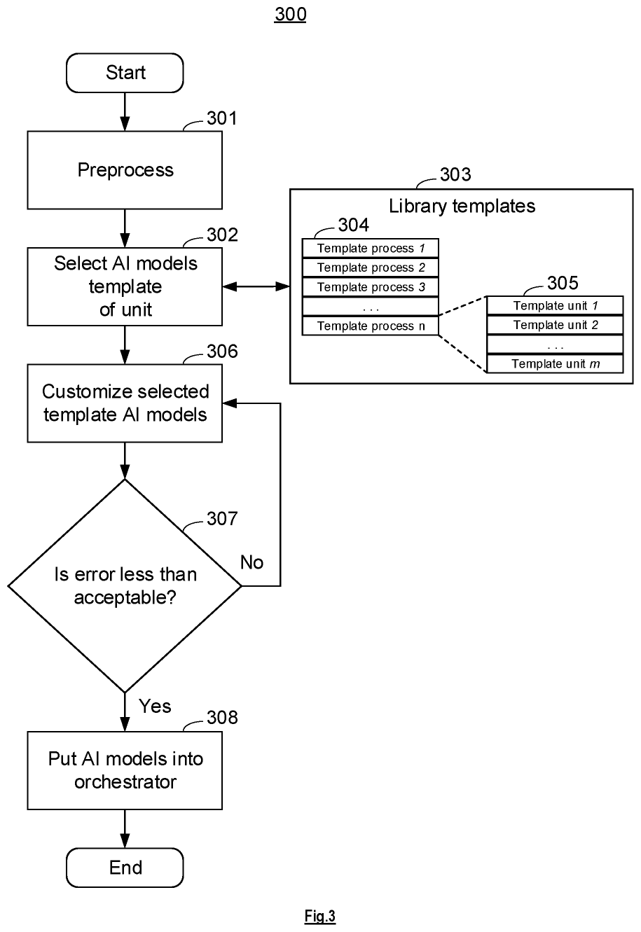

FIG. 4A, FIG. 4B—Appearance of the portable computing device from frontal and rear side, respectively;

FIG. 5—Appearance of the portable computing device in one of the implementation variants for this invention.

### IMPLEMENTATION VARIANT

### Example 1

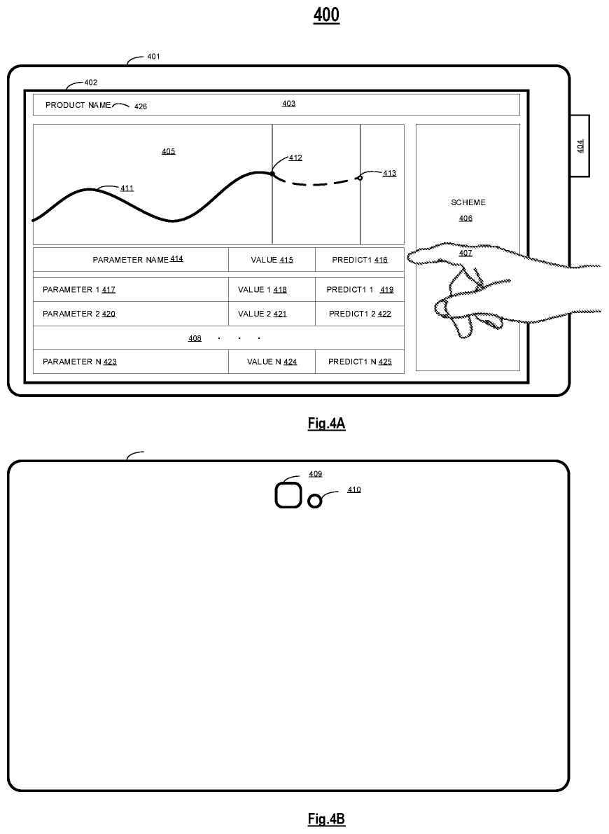

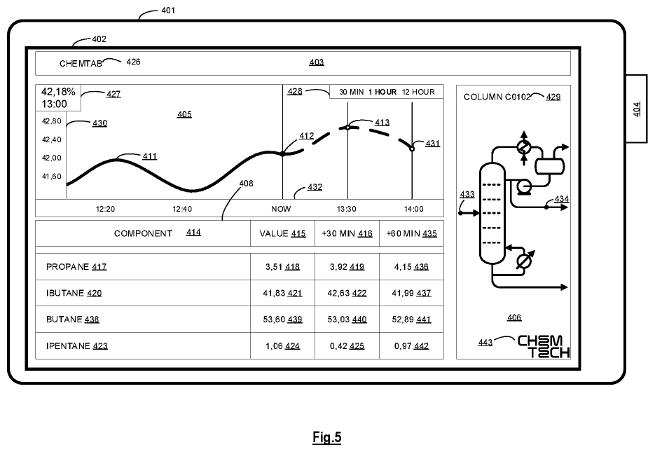

FIG. 5 represents the appearance of the portable computing device 401 FIG. 4A in one of the implementation variants for this invention, applicable to the definition of the raw material flow composition of the tower for separating the isobutane-butane fraction of the gas fractionation process chemical technology system.

In this implementation of the invention, the portable computing device 102 is a tablet computer with diagonal 10.1″, screen resolution 1920×1200, operative storage 8 GB, internal storage 128 GB. Connection 201 with the database 101 in this implementation variant is performed according to the OSI model. The interaction level 202 is represented by physical level; the connection protocol 203 is represented by the universal serial bus. The connection is established through the external port 103. The established connection 204 is one-side, which allows receiving values from the database 101, but not sending values to the database 101. This is provided for the safety of the chemical technology system database.

Inside the portable computing device, the relational database 107 SQL, the orchestrator Azkaban 105, data transfer components in the form of the Python script are located. The data transfer component 108 receives values of process parameters, fills gaps in values of process parameters, eliminates escapes in the process parameter values and transfers AI models 109 from the SQL database. The AI models 109 were received according to the models setting method 300.

In block 301, values from the database 101 are processed: omitted values from process parameter sensors are filled, escapes are eliminated. In block 302, the AI models are selected from AI models library 303: as a chemical technology process 304 the gas fractionation process is selected, as a chemical technology equipment 305 the model of distillation column is selected with one input flow into the central part of the column by height and two output product flows from the top and bottom of the column.

As the AI models pattern 109, this variant of the invention implementation uses the neuron network in which the number of input layer neurons is 48, the number of hidden layer neurons is 10, the number of output neurons is 4 (number of components in the tower feed flow). The Levenberg-Marquardt algorithm with the use of regularization under Bayes' rule is used as a learning algorithm.

In block 306, the AI models pattern was set by mean of iterative method, with definitions of parameters of the number of epochs (2 000), minimal gradient (1.18·10⁻⁶). As the result of these parameters selection, the relative error between actual values and calculated values was less than 0.1%.

The AI models calculation result is sent to the information block of tabular display of values 408 and the information block of a graphical display of values 405.

In this invention implementation, the information block 403 contains information on the name of the product 426, in this particular case CHEMTAB.

The area of the graphical display of values 405 contains a graphical representation of values at time points until current time 411, at the current time point 412, at time points in 30 and 60 minutes in future 413 and 431, respectively.

The area of tabular display of values 408 displays names of columns: 414, 415, 416, 435; names of calculated parameters 417, 420, 438, 423; propane content values at the current time point 418, iso-butane content values at the current time point 421, butane content values at the current time point 439, iso-pentane content values at the current time point 424; propane content values in 30 minutes in future 419, iso-butane content values in 30 minutes in future 422, butane content values in 30 minutes in future 440, iso-pentane content values in 30 in future 425; propane content values in 60 minutes in future 436, iso-butane content values in 60 minutes in future 437, butane content values in 60 minutes in future 441, iso-pentane content values in 60 minutes in future 442.

The information block 406 of the portable computing device contains the tower for separating the isobutane-butane fraction functional diagram applied to this implementation variant of the invention. In this implementation variant, parameters for flows 433 and 434 are calculated.

### Example 2

In a different implementation variant, this invention is similar to the same invention implementation variant under example 1, except the method of connection with the database 101.

According to the method 200, connection with the database is established not under the OSI model but with the use of the image registration object 104. Visual contact with the mnemonic diagram on the chemical technology process operator's display is established in block 205. The contact establishment is represented by placing the portable computing device perpendicular to the flat surface, opposite to the chemical technology process operator's display, with the portable computing device surface angle of divergence in relation to the chemical technology process operator's display plane of 0-10°, and the distance of 40-60 cm.

Further, in block 206, values on the mnemonic diagram of the chemical technology process operator's display are initialized. The initialization process includes recognition of the chemical technology system equipment graphic elements on the mnemonic diagram of the chemical technology system, including input and output streams and the corresponding process parameters such as flow, temperature, pressure, level gauges and other information provided by the on-stream analyzers, established directly at the CTS border, and by the external laboratory. Information initialization is performed by means of the neuron network convolutional model.

Further, in block 207 all values from the mnemonic diagram, with the renewal interval of 10 seconds, are sent to the internal database 107 of the portable computing device 102.

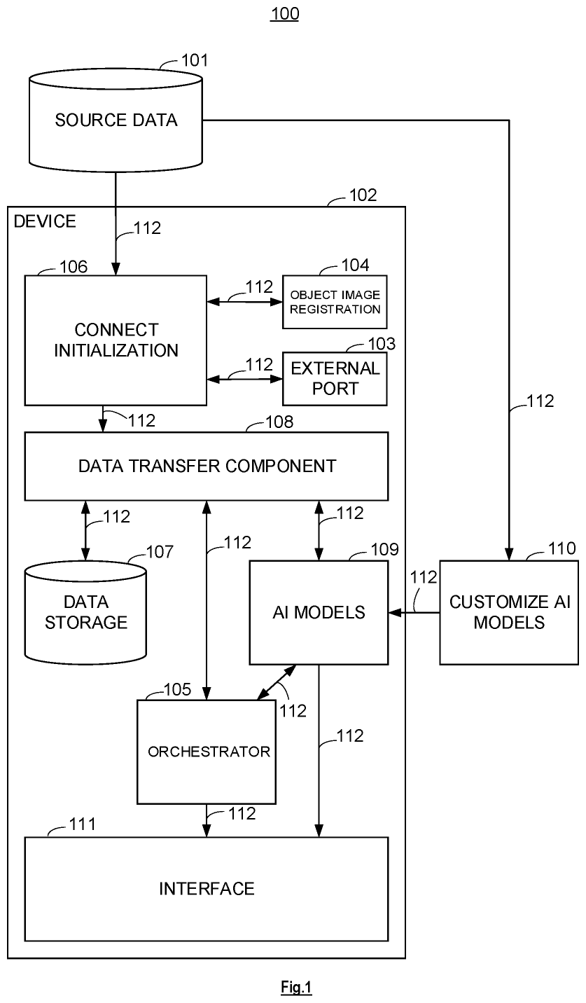

The authors of this invention suddenly found out that after defining the type of connection with the external database 101, FIG. 1 and after setting and sending AI models to the orchestrator 105, FIG. 1, the portable computing device 102 FIG. 1, can operate in the autonomous mode for a long time. Interruption of the portable computing device 102 operation is possible due to external factors independent on the portable computing device operation.

The invention claimed is:

1. System and calculation method for the parameters of the chemical technology system, which are not measured directly or indirectly, on the basis of values of the measured chemical technology system parameters with the use of the mathematical models and a portable computing device with the dedicated graphical interface, where:
the portable computing device contains the connection initialization block, external port, image registration object, data transfer component, pre-defined mathematical models, internal database, orchestrator, graphical interface.
The mathematical models are based on statistic modeling, machine learning or artificial intelligence. Mathematical models are customized on the basis of templates from the mathematical models library.
The connection initialization block determines the type of connection with the chemical technology system database using an external port or image registration object of a portable computing device and provides data transfer with the chemical technology system database.
The orchestrator performs the placement, coordination and control between the database, data transfer component, mathematical models, interface of the portable computing device.
The data transfer component contains a set of software scripts needed to interact with the orchestrator, connection initialization block, portable computing device database, mathematical models, and data transfer between data.
Values from the chemical technology system database, under the communication type determined in the connection initialization block, are placed into the portable computing device database through the data transfer component. From the portable computing device database, values are placed to the mathematical models. In the mathematical models, one or several target parameters of the chemical technology system are calculated, the results of the calculation are saved to the portable computing device database, with subsequent output the values to a graphical interface.

2. System and calculation method for the parameters of the chemical technology system according to claim 1, which calculates parameters in real time regime.

3. System and calculation method for the parameters of the chemical technology system according to claim 1, which calculates parameters in the predictive time span in the future.

4. The connection initialization block according to claim 1, which comprises an external port, and which is based on the Open Systems Interconnection basic reference model, where the model level and connection protocol are selected, and connecting to the chemical technology system database with one-way data transfer is established.

5. The connection initialization block according to claim 1, which uses the image registration object to additionally detect, track, classify and process the objects from playback devices and visual information of a chemical technology system object devices, such as dispatcher consoles, operator panels, personal computer monitors, tablet devices and other devices with the ability to graphically display information of a chemical process.

6. The image registration object according to claim 1, which may be a built-in camera of the portable computing device.

7. Customization of the mathematical models from the templates library according to claim 1, which is carried out with preliminary data preprocessing.

8. The mathematical models library according to claim 1, which consists of templates of mathematical models of various chemical-technological processes. Each set of chemical process models templates contains a set of templates of models of chemical process equipment.

9. The graphical display area of values of the graphical interface according to claim 1, which includes the simultaneous display and indication the values of the parameter of the chemical technology system at the current time, on the historical period and on predictive time span in the future.

10. The table display area of values of the graphical interface according to claim 1, which includes the simultaneous display of the values of parameters of the chemical technology system at the current time and at the predictive time points.

11. The schematic display area of equipment and material flows of the chemical technology system according to claim 1, which includes one or several points of a chemical technology system, for which the parameters are calculated.

12. The parameters of a chemical technology system, calculated by the system and calculation method according to claim 1, which are the main thermodynamic variables, such as temperature, pressure, volume, mass, concentration, density, viscosity and others.

13. The parameters of a chemical technology system, calculated by the system and calculation method according to claim 1, which are the functions of the main thermodynamic variables, such as heat capacity, enthalpy and others.

14. The chemical technology system according to claim 1 which is chemical and/or petrochemical and/or oil refining complexes and/or separate plants and/or other technological plants, where the processes of mass exchange, heat exchange and chemical transformation are applied.

15. The templates from mathematical models library according to claim 1, which include models of technological processes of distillation, such as gas fractionation, crude oil distillation unit, stabilization, complex distillation, precise distillation, extractive distillation, catalytic distillation and other fractionation and distillation processes.

16. The templates from mathematical models library according to claim 1, which include models of technological processes of chemical transformation, such as hydroprocessing, isomerization, alkylation, polymerization, reforming, cracking, and other processes with the implementation of one or more chemical reactions.

17. The templates from mathematical models library according to claim 1, which include models of technological equipment, such as distillation columns, heat exchangers, chemical reactors, pumping and compressor equipment.
